(19) United States
(12) Patent Application Publication
(10) Pub. No.: US 2008/0113059 A1
(43) Pub. Date: May 15, 2008

(54) Micro-Extrusion Line

(75) Inventors: José António Colaco Gomes Covas, Braga (PT); Pedro Antonio Moreira Macovas Costa, V. N. Famalicao (PT)

Correspondence Address: SUGHRUE MION, PLLC, 2100 PENNSYLVANIA AVENUE, N.W., SUITE 800, WASHINGTON, DC, 20037, US

(73) Assignee: UNIVERSIDADE DO MINHO, Braga (PT)

(21) Appl. No.: 10/583,341

(22) PCT Filed: Dec. 17, 2004
(86) PCT No.: PCT/IB04/52850

§ 371 Date: Nov. 9, 2007

(30) Foreign Application Priority Data
Dec. 18, 2003 (PT) 103053

(51) Int. Cl. B29C 47/38; B29C 47/60; B29C 47/80

(52) U.S. Cl. 425/377; 425/378.1; 425/379.1

(57) ABSTRACT

The invention refers to a micro-extrusion line that comprises a single screw (2) micro-extruder (1), a die (7), a cooling bath (17) and a haul-off (19), which together enables the manufacture of extruded profiles from small amounts of raw material. The rotation of the micro-extruder screw, together with the high temperatures created by the heater bands, produces the conveying, melting, mixing and pumping of the material through the die. The extrudate is cooled down in a bath containing a cooling liquid and winded in a coil (19), which has a linear speed higher than that of the extrusion, thus enabling the control of the extrudate cross-section.

### INVENTION BACKGROUND

Some of the large consumption plastic products, such as tubes, profiles, transparent films, raphia, straps, monofilaments, sheets and electric wires, are manufactured in specific extrusion lines, developed to work at the highest production rates. Generally, these lines include an extruder (which melts, homogenizes and pressurizes the polymer), the extrusion head (which shapes the melt) and the accessory equipment (which calibrates and cools down, manipulates, winds or cuts the extrudate, etc). Automation and process control enable reaching outputs that can range between a few hundred to more than a thousand kilograms per hour, depending on the cross-section to be produced, the polymer to process and the equipment sophistication. These values are remarkable, if consideration is given to the low density of plastic materials (typically between 0.9 and 1.5 g/cm³). On the other hand, the various equipment manufacturers fight between themselves for putting forward innovative constructive solutions, which may improve the performance of their equipments, namely in terms of mixing and melting capacity, pressure drops associated to the flow and thermo-mechanical environment to which the material is subjected to.

Nevertheless, the outputs referred to above point towards the high costs associated to the development of new materials and/or products. The production of extrudates for the physical and mechanical characterization of new materials, or of samples of new products, require substantial consumption of materials and time, given the dimension of the equipments, the relative complexity of start up and closing down operations and the time spent on reaching steady state conditions. For that motive, there is a (relatively limited) offer of laboratorial extrusion lines, working with production rates of a few (generally between 3 to 50) kilograms per hour. Obviously, the aim is to carry out experiments/productions with smaller material consumption and, subsequently, to perform scale up to the industrial production scale. However, in some cases, even these equipments evidence too large material consumptions. In fact, the laboratorial synthesis of new polymers or co-polymers, of existing polymers with strictly controlled molecular weight distribution, or of last generation additives (for example, carbon nanotubes, nanoclays, vapour grown carbon fibres) involves complex and long processes, which yield only a few grams of product. In these cases, processing of these materials, i.e., the manufacture of samples that can be characterized from a physical and mechanical point of view, requires the use of laboratorial methodologies that cannot be extrapolated to the industrial practice. For example, melting and mixing are carried in intensive mixers or two-roll mills and shaping is carried out via compression moulding at high temperature, or films are prepared by solvent casting.

### SUMMARY OF THE INVENTION

The present invention aims at solving the above difficulties via the miniaturization of an extrusion line, but where the fundamental concepts and practical functionalities of the industrial equipments remained available. Having concluded that application of the well-established scale up rules from the industrial or laboratorial scales to the new “micro” scale would lead to unpractical results, it was necessary to develop new solutions, which were validated by numerical modelling. The developed line enables the manufacture of small profiles and filaments, in a thermo-mechanical environment that is comparable to that of industrial lines, but using only a few grams (typically between 5 and 10) of material.

The micro-extrusion line that is the object of the present invention is based upon the miniaturization of an extrusion line, i.e., it keeps the principles and general functionalities of equivalent industrial extrusion lines, but at a much smaller scale. In this way, as in the industrial equivalent, the micro-line can produce in a continuous regimen an extrudate of continuous cross-section (profile or rod). However, as steady state is reached rapidly, it is possible to produce samples with only a few grams of raw material. The micro-line comprises a single screw extruder (that is, an extruder consisting of a barrel kept under controlled temperature, inside which an Archimedes-type of screw rotates at constant frequency), a die, a cooling bath and a winding system, all fixed on a common platform.

The extruder is fixed vertically (unlike industrial machines, which use an horizontal construction), in such way that it exhibits the first screw turns in the feeding hopper, thus assuring easier conveying of the solid material. Moreover (unlike conventional machines), screw extraction from the extruder is achieved by simply pulling a lever and this operation can be executed while the screw rotates and without uncoupling the die. In this way, the equipment can be cleaned quickly, observation of the polymer along the screw is possible or the screw can be replaced by another that is better suited to the material to be processed. The die is screwed to the barrel of the extruder, hence fixing dies with different geometries is expedite. Finally, the haul-off has variable speed in order to adjust adequately the extrudate velocity and/or induce the required molecular orientation.

### BRIEF DESCRIPTION OF THE DRAWINGS

The micro-extrusion line and respective components are illustrated in FIGS. 1 to 7.

FIG. 1 represents the global micro-extrusion line, with all the components fixed to a common platform.

FIG. 2 shows the construction of the vertical single screw extruder.

The hopper, which is mounted on top of the extruder, can be viewed in detail in FIG. 3.

FIG. 4 characterizes geometrically the various screws developed.

FIG. 5 shows the geometrical profiles of the different screws.

FIG. 6 identifies the dies that can be screwed to the extruder.

FIG. 7 corresponds to the platform to which the different components are fixed.

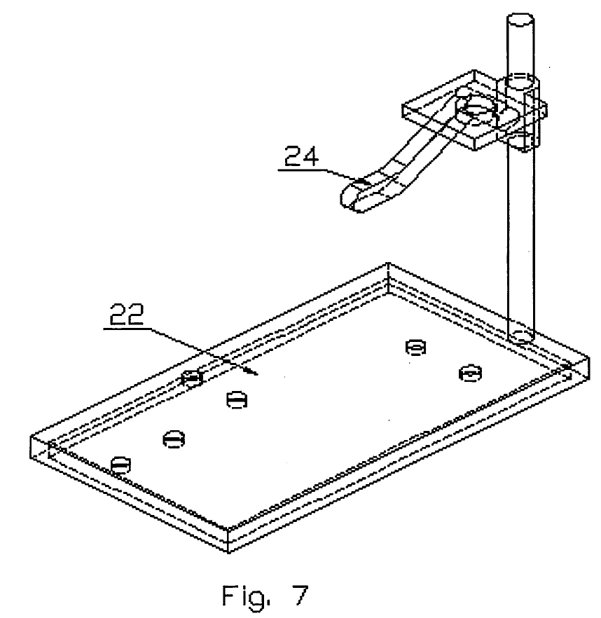

### DETAILED DESCRIPTION OF THE INVENTION

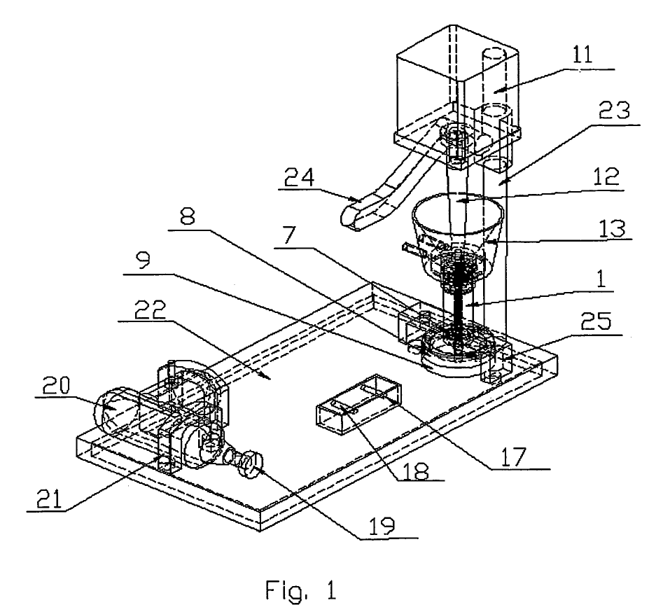

As it can be observed from the drawings, the micro-extrusion line comprises a vertical single screw extruder (1), an extrusion head/die (7), a cooling bath (17) and a haul off (19), all fixed to a common platform (22) (FIG. 1). The extruder screw (2) can be replaced by another more suited to the characteristics of the material to be processed. The extrusion head/die (7) can be replaced by another with the same external dimensions, but prepared for the manufacture of an extrudate with a different cross-section.

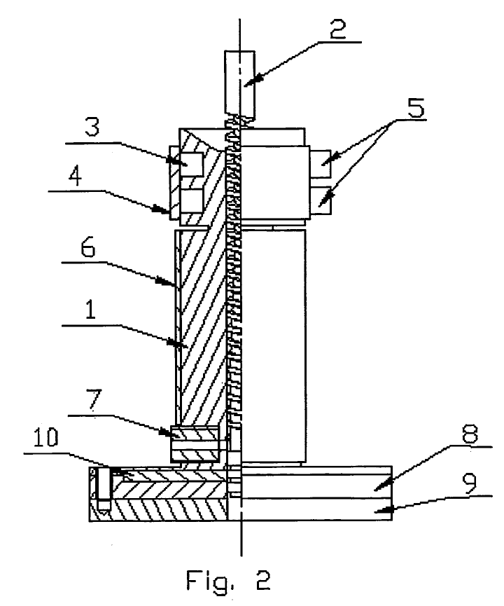

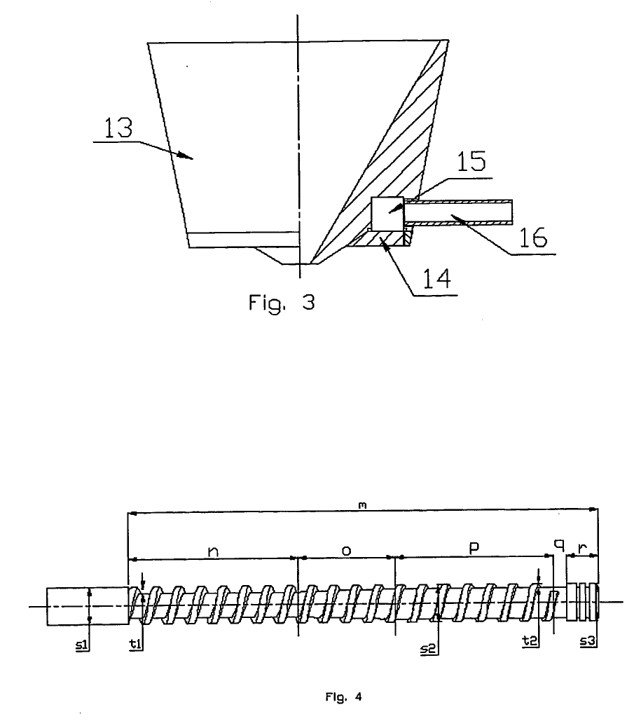

The extruder (FIG. 2) is mounted vertically, i.e., both the hollow barrel (1) and inserted screw (2) are vertical. The barrel's body (2) has three distinct zones. The one on top allows for the circulation of a cooling fluid (that prevents premature material melting). That in the middle corresponds to the main barrel body and is separated from the one on top by means of a transversal groove, which creates a small thermal barrier. Its outer face is covered by a thermal resistance (6). The die (7) for moulding the melted flow can be screwed to the lateral hole connecting the barrel internal and external surfaces. The lower barrel section (1) can be fixed to the platform (22) and has a thermal resistance (8) for a better temperature control of the assembly and a thermal barrier (9) (Teflon disk). The hopper sits on top of the extruder (FIG. 3), its throat being kept cool by means of the circulation of a cooling fluid (this increases the flowability of the raw material). The screw (2), also specifically designed for this machine, has five distinct geometrical zones (FIG. 4). The first three (from top to bottom) aim at collecting and conveying, melting and pressurizing the material, respectively. The fourth zone takes the material towards the die, while the zone at the bottom ensures melt sealing.

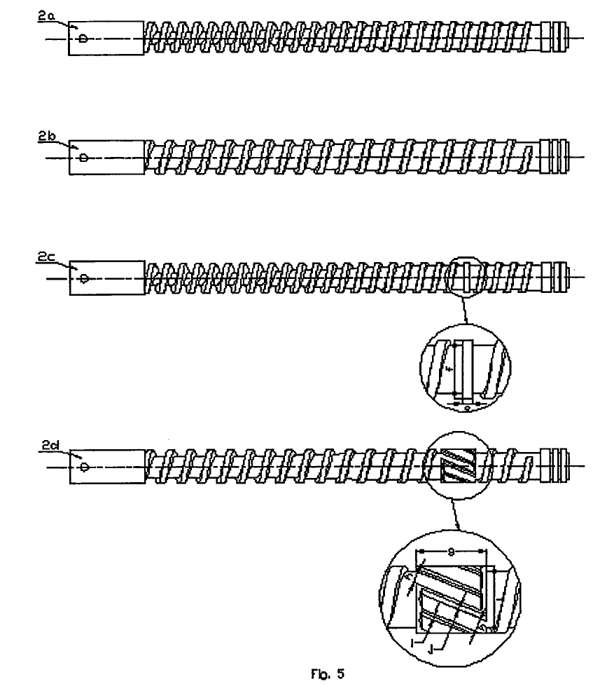

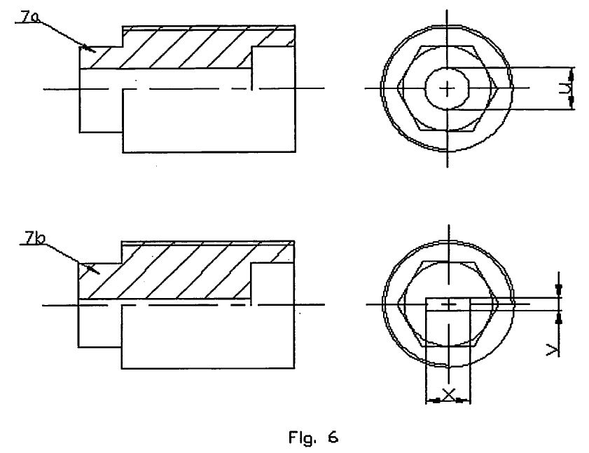

The combined effect of screw rotation and of high barrel temperatures induces material conveying along the screw helical channel and its progressive melting, homogenization, pressurization and pumping through the die, finally taking the cross-section of the flow channel. The various dies represented in FIG. 6 produce the same number of different cross-sections. The screws represented in FIG. 5 have different axial profiles, which differ not only in terms of the relative length of three of the five geometrical zones, but also in the depth of the corresponding channels and in the possibility of the insertion of mixing sections, which produce distributive and dispersive mixing.

The design of these screws was based on non-conventional design principles. As a matter of fact, the use of the established scale up rules [1] using data from industrial or laboratorial lines showed to be inadequate, as the resulting operating conditions and geometrical features were found to be physically inconsistent. Therefore, it was necessary to resort to the computational modelling of the process, by using a software developed at the Department of Polymer Engineering at Minho University [2,3,4]. For a given extruder geometry, operating condition and material properties, the programme predicts the response of the system in terms of mass flow rate, material temperature, pressure profile, power consumption, melting rate, etc. In this way, the geometrical definition of the various screws was obtained iteratively, considering the required performance (output, melting efficiency, pressure generated) and the main characteristics of the materials processed (viscosity levels, range of melting temperatures, thermal conductivity).

After extrusion (when the melt emerges from the die), the melt is submerged in the fluid contained in the cooling bath and winded at constant speed. The latter can be adjusted to control the final diameter of the extrudate and/or to induce a certain level of molecular orientation.

Apart from the components already described, the line includes also sensors and control elements for the main process variables, namely the screw rotation speed, the barrel temperature, the haul-off speed and the cooling rate of the hopper and barrel.

For cleaning and maintenance purposes, as well as replacement, the screw can be extracted vertically by means of pulling a lever.

The micro-extrusion line comprises five main elements, which are represented in the drawing of FIG. 1: extruder, extrusion head, cooling bath and haul-off.

The extruder construction is schematized in FIG. 2. Inside the hollow barrel (1) there is a screw (2) coupled to the motor (11) through the shaft (12). On the top part of the barrel grooves were machined (3), their outer surface being covered by a ring (4), in such a way that two annular channels were created with inlet and outlet holes (5). The main body of the barrel is surrounded by a thermal resistance (6). The die (7) is screwed to this body. The lower side of the barrel is connected to a plate (8) containing a thermal resistance (10). The Teflon disk (9) is placed between plate (8) and platform (22). The extruder is immobilized against the platform (22) by two clamps (25). On top of the extruder sits the conical hopper (FIG. 3), comprising a body (13) where an annular groove was machined (15), and screwed to a base (14). An annular channel with inlet and outlet holes is thus defined (16).

As illustrated in FIG. 4, for the same external diameter and total screw length, the relative length of zones (n), (o) and (p), as well as depths (t₁) and (t₂), can be varied. The length of zone (q), with no flight, is always constant, as it determines the link to the die channel. The same is true to zone (r), with three parallel disks spaced regularly, which ensure sealing against progression of the material being processed. Screw (2) can have different configurations (2a to 2d), as illustrated in FIG. 5. Solutions 2c and 2d in FIG. 5 have special devices that disrupt the main screw flight. In configuration 2c of FIG. 5, the main screw flight is interrupted by a transversal ring, with thickness (e) and diameter (f), which determines the available area for the progression of the material to be processed, forcing it to flow at a higher shear rate. In configuration 2d the disk is replaced by a body with length (g) and diameter (i), where four helical channels with width (h) were excavated. One of these is directly connected with the screw upstream, but has no outlet downstream. Another channel has the reverse configuration, that is, is closed upstream and open downstream. The remaining two channels are closed both upstream and downstream. All the lateral walls shared by the four channels have height (I), except that shared by the two first channels, and all transversal walls, which have height (j). These heights define gaps for polymer flow that is repeatedly subjected to high shear rates.

The extrusion head/die (7) is represented in FIG. 6, which also shows the variants developed (7a), (7b), that produce distinct cross-sections, the first being circular and the second rectangular.

The cooling bath (17) comprises an open rectangular reservoir, which contains two transversal rods (18) that are used to keep the extrudate immersed into the cooling fluid. The cooling winder (19) is powered by a variable speed motor (20) fixed to platform (22) by means of clamps (21). The extruder motor (11) is mounted on column (23), being capable of sliding when the lever (24) is manipulated.

[1] C. Rauwendaal, Polymer Extrusion, Hanser Publishers, 1990

[2] A. Gaspar-Cunha, Modelling and Optimisation of Single Screw Extrusion, PhD Thesis, Universidade do Minho, Guimarāes (2000).

[3] A. Gaspar-Cunha and J. A. Covas, The Design of Extrusion Screws: An Optimisation Approach, Intern. Polym. Process, 16, 229-240 (2001).

[4] J. A. Covas, A. Gaspar-Cunha and P. Oliveira, An Optimization Approach to Practical Problems in Plasticating Single Screw Extrusion, Polym. Eng. Sci., 39, 443-456 (1999).

1.-13. (canceled)

14. Micro-extrusion line which maintains the general principles and functionalities of equivalent industrial extrusion lines, miniaturized for allowing the production of small profiles and filaments in a continuous regimen, in a thermo-mechanical environment, using only a few grams of raw material, typically 5 to 10 g, comprising: (i) a vertical extruder, basically consisting of a barrel (1) kept under controlled temperature, inside which an Archimedes-type screw rotates at a constant frequency, and on which a feeding hopper is mounted (13) for material discharge and an extrusion head/die (7) is screwed; (ii) a cooling bath (17); and (iii) a winding system (19), being all mounted and fixed on the same platform (22) wherein the extruder driven by a motor (11), mounted on a column (23), through which it is capable of sliding by means of a lever (24) comprises a vertical hollow barrel (1), kept under controlled temperature, divided into three different zones, the top one that allows the circulation of a cooling fluid, contains two external grooves (3) covered by a ring (4) so as to create two inlet and outlet annular channels (5), the middle section, separated from the previous one by an external cross-sectional groove, which forms a thermal barrier, covered by the heating thermal resistance (6) and containing a horizontal lateral threaded hole connecting the inner cavity to the outer surface and allowing the connection to the die (7), and a lower zone that enables the fixation to the platform and is connected to a disk (8), which comprises the thermal resistance (10).

15. Micro-extrusion line in accordance with claim 14, wherein that vertical hollow barrel (1) of the extruder has an external diameter of 26 mm and an internal diameter between 5 and 7 mm, the top zone has a length of 20 mm, the middle section has a length between 46 and 48 mm, being separated from the previous one by an external groove with a depth of 6 mm and a height of 1 mm, the horizontal lateral threaded hole for connection to the die has diameter between 6 and 10 mm and the disk (8) a diameter of 64 mm.

16. Micro-extrusion line in accordance with claim 14, wherein the feeding hopper that sits on top of the extruder is a conical hopper with the larger diameter between 70 and 80 mm, comprising a body (13) threaded to the base (14) containing an annular groove close to the inner surface, which defines an annular channel (15) with inlet and outlet (16) and a base (14).

17. Micro-extrusion line in accordance with claim 14, wherein the Archimedes-type screw (2) presents a geometrical definition obtained considering the required performance (output, melting efficiency, pressure generated) and the main characteristics of the materials processed (viscosity levels, range of melting temperatures, thermal conductivity).

18. Micro-extrusion line in accordance with claim 14, wherein the Archimedes-type screw (2) has an external diameter between 5 and 7 mm and length between 90 and 130 mm, being coupled to the shaft (12) of a variable speed motor (11).

19. Micro-extrusion line in accordance with claim 14, wherein the Archimedes-type screw has a pitch between 1 and 2 mm and five distinct zones, having variable relative length, the first (n) having constant channel depth (t1) between 1 and 2 mm, the second (o) having variable channel depth, the third (p) having constant channel depth (t2) between 0.3 and 0.6 mm, the forth (q) 1 to 3 mm long with no screw flight and the fifth (r) comprising three rings between 2 and 3 mm thick, diameter between 5 and 7 mm and spaced 1 mm from each other.

20. Micro-extrusion line in accordance with claim 14 wherein the Archimedes-type screw can have inserted in zone (p), where the main coil was interrupted, a ring with thickness (e) between 1 and 3 mm and diameter (f) between 5 and 6 mm which determines the available area for the progression of the material to be processed, forcing it to flow at a higher shear rate.

21. Micro-extrusion line in accordance with claim 14 wherein the Archimedes-type screw can have inserted in zone (p) a device comprising an inlet channel and an outlet channel with 2 to 3 mm wide and 10 to 12 mm long, separated by three grooves with 9 to 11 mm in length and 2 to 3 mm in width, with lateral walls (I) with height between 0.3 and 0.5 mm, and with wall (j), between the inlet and outlet channels, with height between 0.35 and 0.55 mm, defining these heights small gaps for polymer flow that is repeatedly subjected to very high shear rates.

22. Micro-extrusion line in accordance with claim 14 wherein the extrusion head/die (7) has two connected cylindrical bodies, the bigger one having a thread with diameter between 6 and 10 mm, with an inside hole (u) with two distinct sections, the bigger being hexagonal with equivalent diameter between 4 and 8 mm and the smaller being circular, with diameter between 0.5 and 4 mm, or rectangular with height (v) between 0.5 and 2 mm and width (x) between 2 and 5 mm.

23. Micro-extrusion line in accordance with claim 14, wherein the cooling bath (17) has an open rectangular box with 80×30×20 mm, two horizontal rods (17) being fixed transversally to the inside walls 40 mm apart, which keep the extrudate submerged in the cooling fluid.

24. Micro-extrusion line in accordance with claim 14, wherein the winding system comprises a haul-off and winder (19), with a coil with diameter between 4 and 10 mm, coupled to a variable speed motor (20) fixed to the platform (22).

25. Micro-extrusion line in accordance with claim 14, wherein the rectangular platform (22) of 600×200 mm, with several holes and a vertical column (23) with 450 mm height, having a vertically adjustable support by means of a lever (24).
